(19) United States
(12) Patent Application Publication
(10) Pub. No.: US 2002/0194065 A1
(43) Pub. Date: Dec. 19, 2002

(54) Method for enabling the pricing of video-on-demand to be determined by advertisement volume

(76) Inventors: Haggai Barel, Herzeliyya (IL); Yossi Glick, Herzeliyya (IL)

Correspondence Address: DR. MARK FRIEMAN LTD, C/O BILL POLKINGHORN -DISCOVERY DISPATCH, 9003 FLORIN WAY, UPPER MARLBORO, MD, 20772, US

(21) Appl. No.: 09/879,055

(22) Filed: Jun. 13, 2001

(51) Int. Cl. G06F 17/60

(52) U.S. Cl. 705/14

(57) ABSTRACT

The present invention relates to a method for enabling the calculation of VOD pricing such that is dependent on advertisement volume. In this way the subscriber of VOD is encouraged to view advertisements, as such a choice is rewarded by lower rental prices or alternative benefits. This method defines a mechanism to motivate subscribers to consume more advertisements by offering the subscribers a financial or alternative benefit for such behavior. The concept is to offer the subscriber a few price points for a movie, where the price of the movie is discounted, or otherwise benefited, in reverse proportion to the “ad volume” that the subscriber is willing to endure. In this way the subscriber has a direct and an immediate benefit to “suffer” additional advertisements. In its ideal mode, the present invention provides for a method of streaming video and advertisement content to television devices.

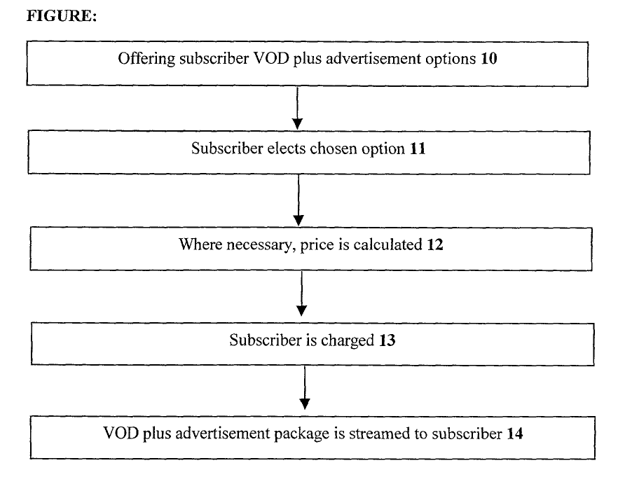

### FIELD AND BACKGROUND OF THE INVENTION

### BACKGROUND OF THE INVENTION

1. Field of the Invention

The present invention relates to a system for streaming video-on-demand (hereinafter, “VOD) with advertisements, and more particularly, to a method for encouraging subscribers of VOD to get benefits in return for consuming more advertisements.

2. Description of the Related Art

The streaming of data between various communications and computing devices has increased phenomenally with the continual development of data networks and the increase in data access bandwidth. More recently, as broadband networks have penetrated the business and home arenas, multimedia data files have become the field of much activity and development, as these data intensive files are sent all over the globe to transfer rich, multimedia data sharing possibilities.

One of the key fields of development has been Video-On-Demand (VOD). VOD provides the ability to start delivering a movie or other video program to an individual Web browser or TV set whenever the user requests it. It is often referred to as streaming video, which is video transmission over a data network. The term “streaming video” implies a one-way transmission to the viewer, in which both the client and server software cooperate for uninterrupted motion. The client side generally buffers a few seconds of video data before it starts sending it to the screen, which compensates for momentary delays in packet delivery. The receiving device for such video data may be a Set Top Box, PC, PDA, cellular device or any other multimedia enabled communications device. The most popular device is typically Interactive TV (ITV) or Internet TV, which is primarily an Internet service for home TV use. This service incorporates a set-top box that connects the TV to a modem and telephone line. The user interface is specially modified for viewing on an interlaced TV screen rather than a computer monitor. WebTV (http://www.webtv.com/)was the first such service to obtain widespread distribution. The first Internet TV service that obtained widespread distribution of its set-top boxes in the retail channel. In 1997, it was acquired by Microsoft Corp (www.microsoft.com). WebTV uses an analog modem and telephone line to deliver the Web to the TV set.

Current VOD technologies include various ways of delivering and displaying content on ITV. The providers of both the content and the hardware for VOD are typically locked into two revenue models: subscription and advertising. Like traditional television before it, subscription has proven difficult to sell to the masses, many of who prefer to utilize the abundance of Internet information for a more reasonable price. The advertising model is more attractive, but has also has a difficult time penetrating, since the critical mass of users has not been reached, and subscribers generally prefer advertisement-free viewing of content which they have paid for.

There is thus a widely recognized need for, and it would be highly advantageous to have, a system that can enable a method that provides an incentive to subscribers of VOD and ITV to welcome additional advertisements, such that both advertisement revenues are increased, and user preferences are satisfied.

The present invention provides a method for enabling increased advertisement revenues and subscriber satisfaction for subscribers to VOD services.

### SUMMARY OF THE INVENTION

According to the present invention there is provided a method for enabling Video-On-Demand (VOD) subscribers to influence the pricing of VOD packages, by making the price dependant of advertisement volume. In this way the price of the movie is determined by the subscriber, in response to the volume of advertisements received by the subscriber.

This method entails the defining of a mechanism to motivate subscribers to consume more advertisements. This is achieved by offering the subscribers a financial benefit for such behavior. The concept is to offer the subscriber a few price points for a movie, where the price of the movie is discounted in reverse proportion to the “ad volume” that the subscriber is willing to endure. In this way the subscriber has a direct and an immediate benefit from “suffering” additional advertisements.

### BRIEF DESCRIPTION OF THE DRAWINGS

The invention is herein described, by way of example only, with reference to the accompanying drawing, wherein:

The FIGURE is an illustration of the basic methodology, according to the present invention.

### DESCRIPTION OF THE PREFERRED EMBODIMENT

s The present invention relates to a method for enabling the calculation of VOD pricing such that it is dependent on advertisement volume. In this way the subscriber is encouraged to view advertisements, as such a choice is rewarded by lower rental prices or alternative benefits.

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

Specifically, the present invention can be used to provide incentives to VOD subscribers to consume additional advertisements, in a way that immediately benefits subscribers, both by influencing the price and the nature of the service requested.

This method defines a mechanism to motivate VOD subscribers to consume more advertisements by offering the subscribers a financial or alternative benefit for such behavior. The concept is to offer the subscriber a few price points for a movie, where the price of the movie is discounted in reverse proportion to the “ad volume” that the subscriber is willing to endure. In this way the subscriber has a direct and an immediate benefit to “suffer” additional advertisements. The method of the present invention also directly and immediately benefits the content providers by simultaneously encouraging increased advertisement revenues, since those subscribers electing more intensive advertising packages permit increased streaming of advertisements, as well as increased subscriber revenues, from those subscribers electing more expensive, limited-advertisement packages. The method of the present invention also directly benefits advertisers, by enabling highly targeted advertisements based on additional subscriber behavior data.

When referring to packages, the present invention includes any programs, play lists, directories, catalogs etc., whether pre-configured or dynamically configured, of content that is streamed to subscribers, wherein the content includes some combination of video data and advertisements, including the possibility of a totally video-based program with no advertisements. Such packages, according to the present invention, can be accessed by television sets, and additionally by a variety of user devices, such as Interactive TV's, Web TV's, PC's, PDA's, mobile phones, and any other multimedia-enables computing and communications devices. Packages, according to the present invention may be pre-programmed lists, or customized according to the preferences of each individual subscriber.

When referring to VOD subscribers, the present invention refers to users of any networks, including IP based networks, such as dial up, ISDN, DSL, cable, satellite and wireless networks, or any alternative networks.

The principles and operation of a system and a method according to the present invention may be better understood with reference to the drawing and the accompanying description, it being understood that this drawing is given for illustrative purposes only and are not meant to be limiting, wherein:

According to the FIGURE, a method is provided as follows:

i. offering a subscriber a plurality of VOD plus advertisements options or packages 10. This may be in the form of price points (a variety of packages at different prices) for a video-on-demand, where the price of the movie is discounted in reverse proportion to the “ad volume” that the subscriber is willing to endure. The subscriber may be offered more or less intensive advertisement packages, with corresponding prices. In the case where a subscriber is prepared to pay a maximum fee for no advertisements, the package would consist of VOD alone.

ii. a subscriber elects a VOD and advertising package 11. There may be any variety of packages, with the principle being that the more advertisements elected, the greater the discount to the subscriber, and alternatively, the less advertisements wanted, the more expensive the package. Packages may be elected by mouse, voice, remote control, stylus pen, keys or any other input mechanisms.

iii. In the case where no exact price is presented, the exact price is calculated 12 according to the subscriber's choice of package. In this way the subscriber can actualize his/her personal preferences in order to achieve the desired package and price. Calculations of the subscriber's request may be processed on either the subscriber device or the server.

iv. the subscriber's account is automatically charged, or the subscriber is otherwise requested to pay the package price, as chosen or calculated above.

v. streaming the package to the subscriber 14 TV or alternative device. The present invention also enables the subscriber to modify viewing or advertisement options during the streaming of the movie. All subscriber activity may be monitored and analyzed in order to provide the content provider with valuable subscriber behavior data.

It should be noted that the content for the various packages may be comprised of a dynamic or pre-defined nature. For example, a content provider may provide a selection of 10 packages with various advertising intensities or types. According to this example, each package will be pre-configured as a playlist (a list with pre-configured logical content) such that the particular package chosen by a single or group of subscribers will be streamed to all the subscribers who chose that package. Alternatively, a dynamic or customized method may be used such that each subscriber can choose a unique package, based on his/her personal preferences, which will be dynamically streamed to the particular subscriber. Packages may be determined by multiple factors, such as type of advertisements, volume of advertisements, timing of advertisements, etc. The present invention may be operable according to any available streaming technologies, on any networks.

Concept Attributes and Dependencies

1. The unit of measure of “ad volume” can be in seconds/minutes (total number of time allocated to show ads), occurrences (number of ad breaks) or quantity (number of ads show during a movie).

2. The present invention provides for a means by which a subscriber is provided with a plurality of price points, or packages, from which to choose. This number, or the types of these packages are limited to any particular number of price points.

3. The layouts in which the price points are displayed to the subscriber can be in any structure, either vertical (as in the above example), Horizontal or any other layout.

4. The discounted price points can be computed in any type of algorithm, either on the server and/or in the subscriber device (i.e. Set Top Box, PC or mobile etc.).

5. The subscriber can select the desired price point in anyway, including remote control keys (i.e. up or down), numbers (i.e. press 1 for the 1st price point), voice commands, mouse generated commands, keyboard or keypad generated commands and commands generated by any other input mechanisms, whether using wireline or wireless devices.

6. The subscriber may choose from additional price factors. In t he above example, the price is only dependent on the “ad volume”. It is likely that in a commercial deployment, the operator might decide to extend the movie-pricing model, to be dependant on additional factors such as “rental duration” (i.e. 24 hr, 48 hr) and/or time of day (i.e. morning hours, prime time). The present invention provides for any case that “ad volume” is part of the formula to calculate the price, or alternative benefits, to the subscriber.

7. The service may operate according to various operator types. Typically, such VOD service will be provided by cable, DSL and FTTH (fiber-to-the-home) video service providers. The service may be operated by any alternative broadband service providers, using any wireline or wireless networks.

8. The present invention may be utilized by various subscriber devices. The primary target device for the application of the present invention is the television via a Set Top Boxes. Optionally, the present invention functions with other type of devices, such as PCs, mobile telephones, PDAs and other mobile computers and communication devices that are multimedia-enabled.

The present invention may operate under various economic models, with the preferred embodiment being the economics of “volume discount”. When the subscriber buys a movie with the maximum volume of advertisements, this will result in the highest possible revenue (revenue from subscriber plus revenue from advertisers) for the operator, which results in a classical win-win situation for both the subscriber and for the operator. However, any alternative economic model is also operable with the present invention, such that advertising volume is a factor is calculating subscriber price and/or benefits.

An Example of a “Movie Order”

This is to illustrate the price section on the TV screen, where the subscriber buys (or rents) a movie.

Movie Price:

$1 with 10 minutes of ads

$2 with 5 minutes of ads

$5 without any ads

The subscriber may use the remote control or any other means to select one on the above price points.

### ALTERNATE EMBODIMENTS

Several other embodiments are contemplated by the inventors. For example, a user may choose a high intensity advertisement option, and instead of receiving a monetary (price) benefit, may receive benefits such as: better streaming quality, a larger selection of content, better timing of streaming, service benefits, bonus points (such as frequent viewer points), coupons, future discounts, trade-in points or various other benefits that a content or service provider would be able to provide. Benefits may also be contingent upon subscriber usage (particular usage patterns may be rewarded), including variables such as time of usage, type of network access, type of usage, intensity of usage, quality of usage, quantity of usage, features used by subscriber, date of usage, location of usage, device of usage and any other usage patterns that may be encourage by content or service providers.

These benefits, when diminished, may be viewed as costs for a chosen package. Any business method involving the subscriber choice of advertisement volume in return for benefits, is included within the scope of the present invention.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A method for determining prices for video-on-demand (VOD) based on advertising volume, comprising the steps of:
i. offering at least one subscriber a plurality of VOD plus advertisement packages;
ii. electing at least one VOD plus advertising package, such that the cost of a package decreases with an increase in advertisement volume; and
iii. charging a subscriber for said at least one elected package.

2. The method of claim 1, wherein said packages are displayed on an interactive television device.

3. The method of claim 1, wherein said packages are displayed on a device selected from the group of Set-Top-Boxes, televisions, PCs, mini-computers, PDAs, cellular handsets and mobile computers.

4. The method of claim 1, wherein said cost of package increases with a decrease in advertisement volume.

5. The method of claim 1, wherein said cost of package is a non-monetary value selected from the group consisting of streaming quality, selection of content, timing of streaming, service benefits, bonus points, coupons, future discounts and trade-in points.

6. The method of claim 1, wherein said electing of at least one VOD plus advertising package influences subscriber benefits, such that said benefits are selected from the group consisting of lower prices, better streaming quality, a larger selection of content, better timing of streaming, service benefits, bonus points (such as frequent viewer points), coupons, future discounts and trade-in points.

7. The method of claim 1, wherein said charging is based on a calculation of the chosen package, such that said calculation is selected from the group comprising of processing said calculation on a subscriber device and processing said calculation on a server device.

8. The method of claim 1, further comprising streaming said package to said subscriber.

9. A method for determining benefits for video-on-demand (VOD), based on subscriber exposure to advertisements, comprising the steps of:
i. offering at least one subscriber a plurality of VOD viewing options;
ii. electing at least one VOD option from said viewing options, such that the benefits for the subscriber are inversely related to the volume of advertisements chosen;
iii. calculating at least one chosen viewing option;
iv. charging the subscriber for said viewing option; and
v. streaming the VOD to the subscriber.

10. The method of claim 9, wherein said benefits are contingent upon subscriber usage, said usage selected from the group consisting of time of usage, type of network access, type of usage, intensity of usage, quality of usage, quantity of usage, features used by subscriber, date of usage, location of usage and device of usage.

11. The method of claim 9, where said streaming the VOD is streamed to an interactive television device.

12. The method of claim 9, wherein said VOD is streamed to a television device, such that said VOD has content that is selected from the group consisting of videos, movies, TV shows with multiple episodes, kids content, educational content, movie clips, cartoons, online training.
